(19) United States
(12) Patent Application Publication
(10) Pub. No.: US 2025/0140970 A1
(43) Pub. Date: May 1, 2025

(54) FRICTION STIR WELDING METHOD AND BATTERY PACK

(71) Applicant: HONDA MOTOR CO., LTD., Tokyo (JP)

(72) Inventors: Akio YOKOYAMA, Tokyo (JP); Ayumu HONDA, Tokyo (JP); Toshihide SUNADA, Tokyo (JP)

(73) Assignee: HONDA MOTOR CO., LTD., Tokyo (JP)

(21) Appl. No.: 18/925,061

(22) Filed: Oct. 24, 2024

(30) Foreign Application Priority Data
Oct. 27, 2023 (JP) 2023-184900

(51) Int. Cl. H01M 10/6556; B23K 20/12; H01M 10/613

(52) U.S. Cl. CPC H01M 10/6556; B23K 20/122; H01M 10/613

(57) ABSTRACT

A friction stir welding method welds at least two members to be welded by overlapping the members to be welded and moving a welding tool. The friction stir welding method has a step of forming a closed space at a terminal end of a welding line which is a movement track of the welding tool, and a step of moving the welding tool to inside the closed space and pulling out the welding tool from the members to be welded.

### CROSS-REFERENCE TO RELATED APPLICATIONS

This application is based on and claims priority under 35 USC 119 from Japanese Patent Application No. 2023-184900 filed on Oct. 27, 2023, the entire content of which is incorporated herein by reference.

### TECHNICAL FIELD

The present disclosure relates to a friction stir welding method and a battery pack formed by the friction stir welding method.

### BACKGROUND ART

Friction stir welding (FSW) is known as a method of welding metal members. In the friction stir welding, metal members, which are two members to be welded, overlap each other, one metal member is softened by frictional heat and penetrated by pressing a welding tool against the one metal member while rotating, and the one metal member and the other metal member are stirred by a rotational force of the welding tool to cause plastic flow. Thereafter, a plastically flowing material rapidly loses the frictional heat and is cooled and solidified, and the one metal member and the other metal member are welded to each other.

In the friction stir welding method, a hole portion (hereinafter, probe hole portion) is formed when the welding tool is pulled out at a terminal end.

FIG. 1 is a cross-sectional view showing a state in which a welding tool 10 is pulled out at a terminal end, and FIG. 2 is a schematic diagram of a welding end when the welding tool 10 is moved linearly and the welding tool is pulled out at the terminal end. In FIG. 2 (also in FIGS. 3 and 4), a reference numeral 11A denotes a welding mark formed by a shoulder 11, and a reference numeral 12A denotes a probe hole portion formed when a probe 12 is pulled out. A thick solid line in the figure is a welding line 20 which is a movement track of an axis of the probe 12. The welding line 20 is a virtual line for explanation purposes, and does not generally remain after welding.

In the welding tool 10, as shown in FIG. 1, the probe (projection) 12 protrudes along the axis from a distal end of the columnar shoulder 11. As shown in FIG. 2, when the welding tool 10 is linearly moved as indicated by an arrow Y1 and the welding tool 10 is pulled out at a terminal end of the welding line 20, the probe hole portion 12A having a shape of the probe 12 is formed in the welding end. When the probe hole portion 12A is formed, an interface between one metal member M1 and the other metal member M2 is exposed (see FIG. 1). A periphery of the probe hole portion 12A has a narrow welding range and a weak welding strength.

In order to solve such problems, JP2012-152759A discloses that the welding tool 10 is linearly moved as indicated by an arrow Y2, and then the welding tool is moved in a manner of an arc, more specifically, in a J-shape at the terminal end of the welding line 20 to form a welding end, as shown in FIG. 3.

However, even in the welding method described in JP2012-152759A, it is required to improve welding strength. In particular, in a case where a flow path is formed between two members to be welded, a water pressure acts on a periphery of a probe hole portion, and thus water leakage occurs when a welding strength is weak.

### SUMMARY OF INVENTION

The present disclosure provides a friction stir welding method capable of improving a welding strength at a terminal end of friction stir welding, and a battery pack welded by the friction stir welding method.

A first aspect of the present disclosure relates to a friction stir welding method of welding at least two members to be welded by overlapping the members to be welded and moving a welding tool, the friction stir welding method having:
forming a closed space at a terminal end of a welding line which is a movement track of the welding tool; and
moving the welding tool to inside the closed space and pulling out the welding tool from the members to be welded.

A second aspect of the present disclosure relates to a battery pack including: a battery module in which a plurality of battery cells are laminated;
a battery case that accommodates the battery module; and
a plate member that is welded to the battery case to form, between the plate member and the battery case, a flow path configured to allow a fluid for battery temperature control to flow therethrough,
in which at least one of the battery case or the plate member includes a convex portion protruding toward an other one of the battery case or the plate member,
the convex portion is welded by friction stir welding to form a welding portion,
the welding portion includes a linear portion extending in an extension direction of the convex portion and a circular portion formed at one of ends of the linear portion, and
a width of the circular portion is larger than a width of the linear portion.

According to the aspects of the present disclosure, a welding strength formed by the welding tool at the terminal end of the welding line can be improved.

### BRIEF DESCRIPTION OF DRAWINGS

Exemplary embodiment(s) of the present invention will be described in detail based on the following figures, wherein:

FIG. 1 is a cross-sectional view showing a state in which a welding tool 10 is pulled out at a terminal end;

FIG. 2 is a schematic diagram of a welding end when the welding tool 10 is moved linearly and pulled out at the terminal end;

FIG. 3 is a schematic diagram of a welding end when the welding tool 10 is linearly moved, and then moved in a manner of an arc (J-shape) at a terminal end and pulled out;

FIG. 4 is a schematic diagram of a welding end when the welding tool 10 is linearly moved, and then moved in a circular manner at a terminal end and pulled out;

FIG. 5 is a schematic diagram showing the welding end in FIG. 4;

FIG. 6 is a perspective view showing an inside of a battery pack 50;

FIG. 7 is a view showing a cover plate 70 which is friction stir welded to a bottom plate 61 of a battery case 60;

FIG. 8 is a view showing a bottom surface of the battery case 60 to which the cover plate 70 is welded;

FIG. 9 is a cross-sectional view taken along a line A-A in FIG. 8; and

FIG. 10 is an enlarged view of a portion B in FIG. 8.

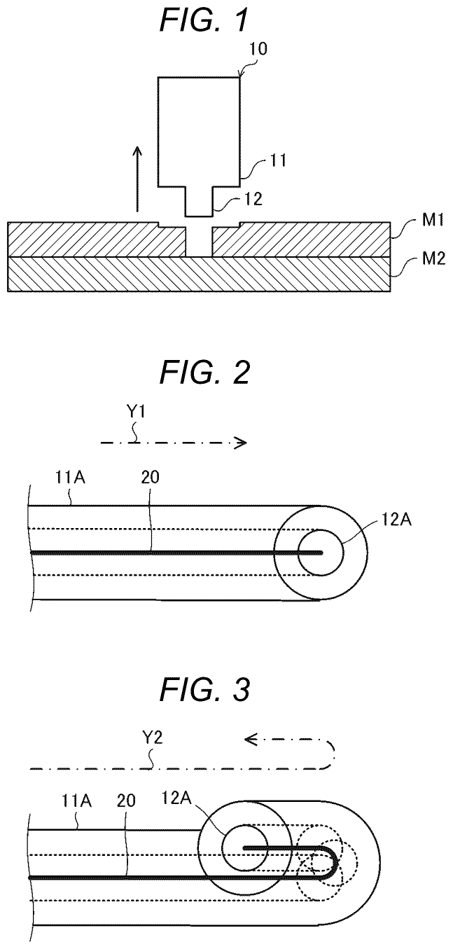

### DESCRIPTION OF EMBODIMENTS

Hereinafter, an embodiment of a friction stir welding method of the present invention and a battery pack formed by the friction stir welding method will be described with reference to the drawings.

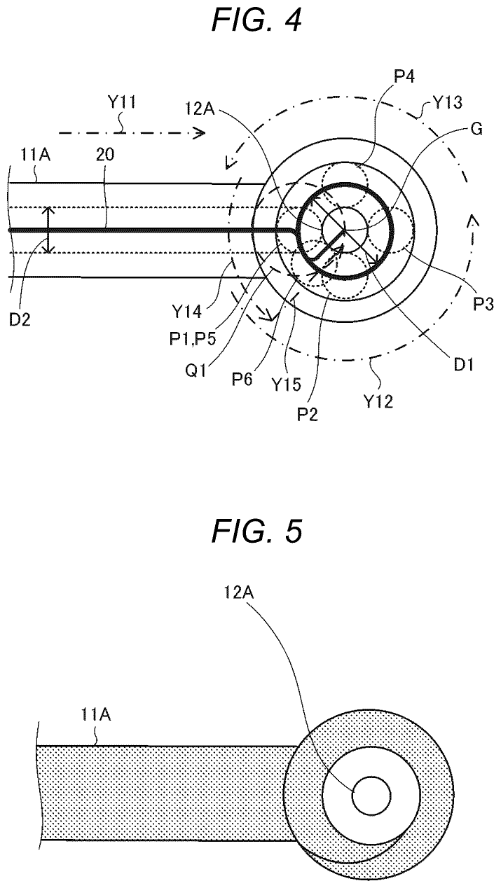

FIG. 4 is an embodiment of the friction stir welding method of the present disclosure, and is a schematic diagram when a welding tool 10 is linearly moved, and then moved in a circular manner at a terminal end and pulled out.

The friction stir welding method of the present embodiment includes a terminal end forming step of forming a closed space at a terminal end of a welding line 20 which is a movement track of a probe 12 of the welding tool 10, and a pulling-out step of moving the welding tool 10 to inside the closed space and pulling out the welding tool 10.

In the terminal end forming step, as shown in FIG. 4, the probe 12 of the welding tool 10 is linearly moved, for example, as indicated by an arrow Y11, and then moved from a position (position P1 in the figure) before a target pulling-out position G in a circular manner around the target pulling-out position G. A broken line Q1 in the figure indicates a shoulder 11 when the probe 12 is at the position P1. The position P1 is, for example, a point at which the shoulder 11 reaches the target pulling-out position G. The target pulling-out position G is a target position corresponding to an axis of the probe 12 when the welding tool 10 is pulled out.

Describing a treatment in the terminal end forming step more specifically, the welding tool 10 is moved counterclockwise around the target pulling-out position G at the terminal end such that the probe 12 is moved in an order of the position P1, a position P2, a position P3, a position P4, and a position P5 (position P1), as indicated by arrows Y12 and Y13, for example.

By moving the welding tool 10 in a circular manner around the target pulling-out position G, a circular closed space is formed in the welding line 20. When a diameter of the circular closed space is D1, and a diameter of the probe 12 is D2, D1>D2 is preferably satisfied.

The closed space is preferably formed such that parts of the welding line 20 overlap each other. That is, in the present embodiment, a track of the probe 12 from the position P5 to a position P6 overlaps a part of a track of the probe 12 from the position P1 to the position P2. In this way, by moving the welding tool 10 such that the parts of the welding line 20 overlap each other, the closed space can be reliably formed.

However, if an overlapping amount is too large, a time required for a welding treatment increases. Therefore, the overlapping amount is preferably 180° or less, more preferably 90° or less, and still more preferably 60° or less around the target pulling-out position G.

Subsequently, the probe 12 is moved to inside the circular closed space to reach the target pulling-out position G.

In the pulling-out step, the welding tool 10 is pulled out after the probe 12 reaches the target pulling-out position G. At this time, by setting the diameter D1 of the closed space to be larger than the diameter D2 of the probe 12 in advance, the probe 12 of the welding tool 10 which forms a probe hole portion 12A after the welding tool 10 is pulled out can be positioned inside the closed space.

In this way, by pulling out the welding tool 10 at the inside of the closed space formed at the terminal end of the welding line 20, a welding region of two members to be welded is formed outside a pulling-out position (target pulling-out position G). In FIG. 5, only a region of the welding region that does not overlap the shoulder 11 of the welding tool 10 at the time of pulling out is hatched. That is, the welding region in which metal members M1 and M2 are stirred and plastically flowed is formed outside the probe hole portion 12A. Therefore, even if a welding strength of the welding region at the pulling-out position (target pulling-out position G) is low, the welding strength can be improved because the welding is firmly performed outside the probe hole portion 12A.

In the present embodiment, the welding tool 10 is moved counterclockwise around the target pulling-out position G, but it goes without saying that the welding tool 10 may be moved clockwise. The closed space is not limited to a circular shape, and may be a polygonal shape such as a triangular shape or a quadrangular shape, or may be an elliptical shape, as long as the space is a closed space when viewed from above.

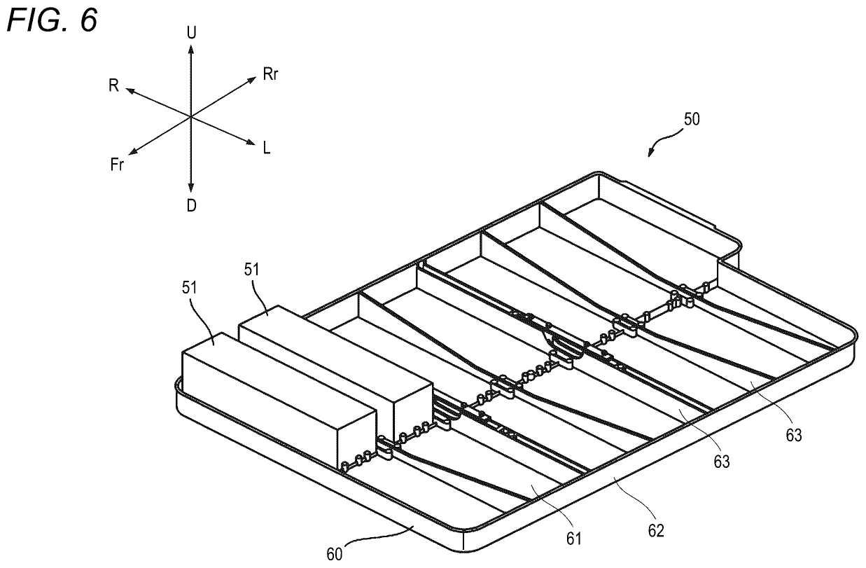

Next, a battery pack to which the friction stir welding method described above is applied will be described with reference to FIGS. 6 to 8. In the following description, for convenience, a coordinate system including a front-rear direction, a left-right direction, and an upper-lower direction orthogonal to each other is used. In the drawings, a front side is denoted by Fr, a rear side is denoted by Rr, a left side is denoted by L, a right side is denoted by R, an upper side is denoted by U, and a lower side is denoted by D. However, these directions are not related to a direction when the battery pack is mounted on a device. For example, when the battery pack is mounted on a vehicle, an upper-lower direction of the battery pack may be oriented in a traveling direction of the vehicle or in a vehicle width direction when the battery pack is mounted on the vehicle.

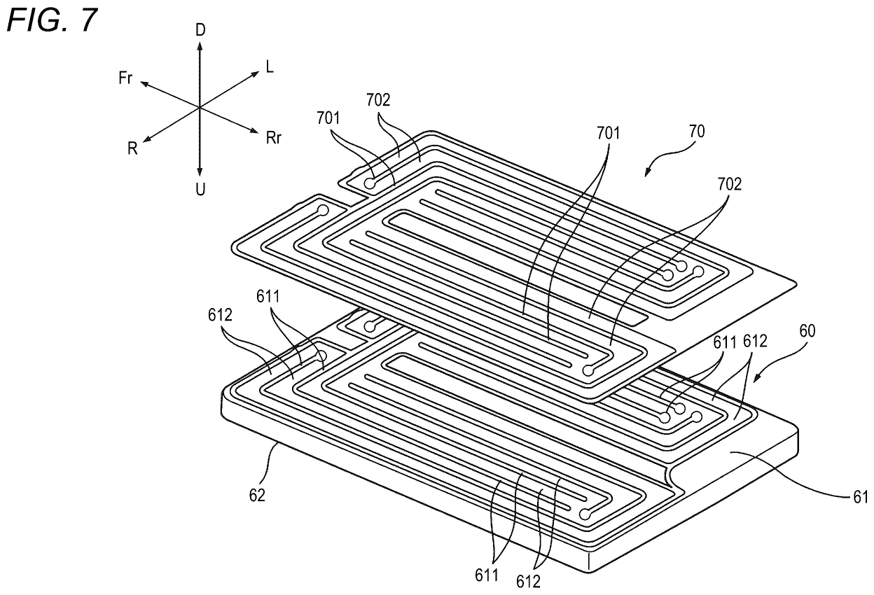

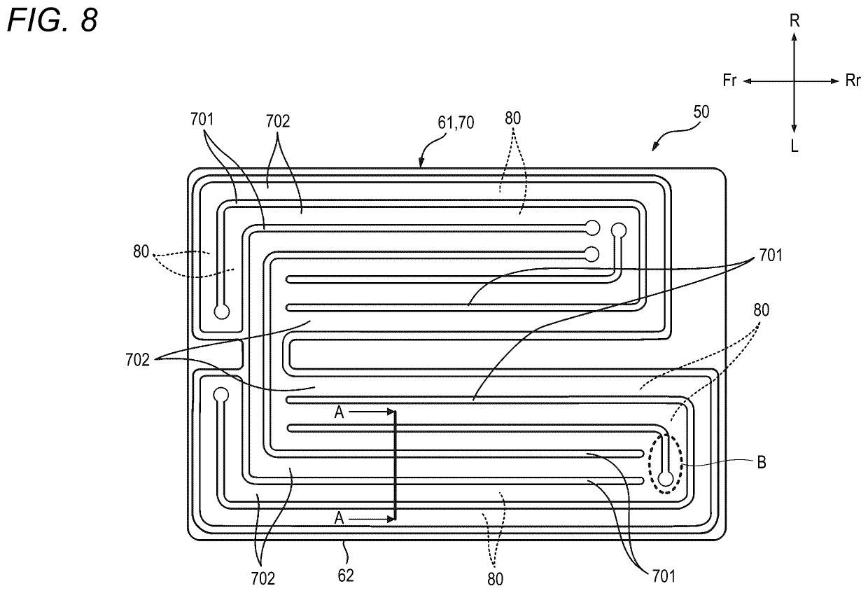

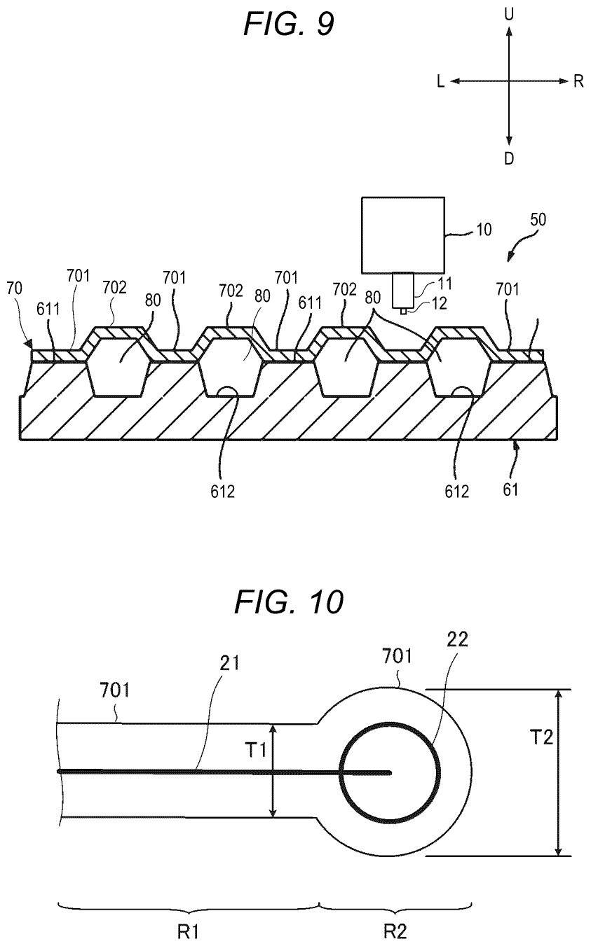

FIG. 6 is a perspective view showing an inside of a battery pack 50, FIG. 7 is a view showing a cover plate 70 which is friction stir welded to a bottom plate 61 of a battery case 60, FIG. 8 is a view showing a bottom surface of the battery case 60 to which the cover plate 70 is welded, FIG. 9 is a cross-sectional view taken along a line A-A in FIG. 8, and FIG. 10 is an enlarged view of a portion B in FIG. 8.

As shown in FIG. 6, the battery pack 50 includes battery modules 51 in which a plurality of battery cells are laminated, and the battery case 60 that accommodates the battery modules 51. In FIG. 6, only two battery modules 51 are shown, and the other battery modules 51 are omitted. The number and arrangement of the battery modules 51 accommodated in the battery case 60 may be set as appropriate.

As shown in FIG. 6, the battery case 60 includes the rectangular bottom plate 61 on which a plurality of battery modules 51 are mounted, a side wall 62 standing from an outer edge portion of the bottom plate 61, and a plurality of cross members 63.

The battery case 60 is formed of, for example, an aluminum alloy containing aluminum. More specifically, the bottom plate 61, the side wall 62, and the plurality of cross members 63 of the battery case 60 are formed by aluminum die casting. The aluminum die casting is formed by melting an aluminum alloy, filling the aluminum alloy into a metal mold at a high speed using a die casting machine, and then applying a high pressure. By forming the battery case 60 from an aluminum alloy, a weight of the battery pack 50 can be reduced.

As shown in FIG. 7, by friction stir welding the plate-shaped cover plate 70 that is arranged below, the bottom plate 61 of the battery case 60 is covered with the cover plate 70. The cover plate 70 is, for example, a press-molded product made of iron. Referring also to FIG. 8, a refrigerant flow path 80 is formed between the bottom plate 61 of the battery case 60 and the cover plate 70. The battery module 51 accommodated inside the battery case 60 is cooled and/or warmed by a refrigerant that flows through the refrigerant flow path 80, so that a temperature of a battery can be adjusted.

More specifically, the bottom plate 61 and the cover plate 70 are each provided with irregularities. The bottom plate 61 is provided with convex portions 611 protruding toward the outside of the battery case 60, that is, a cover plate 70 side, and concave portions 612 recessed toward a side opposite to the cover plate 70 with respect to the convex portion 611.

The cover plate 70 is provided with convex portions 701 protruding toward a bottom plate 61 side, and concave portions 702 recessed toward a side opposite to the bottom plate 61 with respect to the convex portion 701.

In the friction stir welding, as shown in FIG. 8, the welding tool 10 is moved along an extension direction of the convex portions 611 and 701 while the convex portion 611 of the bottom plate 61 and the convex portion 701 of the cover plate 70 are in contact with each other. At this time, the terminal end forming step of forming the closed space at the terminal end of the welding line 20 which is the movement track of the probe 12 of the welding tool 10, and the pulling-out step of moving the welding tool 10 to inside the closed space and pulling out the welding tool 10 as described above are executed.

By moving the welding tool 10 in a circular manner around the target pulling-out position G in the terminal end forming step, as shown in FIG. 10, a linear portion 21 extending in the extension direction of the convex portions 611 and 701 and a circular portion 22 formed at a terminal end which is one of ends of the linear portion 21 are provided at a welding portion on the convex portions 611 and 701. A width, that is, a diameter of the circular portion 22 is larger than a width of the linear portion 21 extending linearly.

Then, in the pulling-out step, after the welding tool 10 is moved to inside the circular portion 22 which is a closed space, the probe 12 forms the probe hole portion 12A at a center of the circular portion 22 by pulling out the welding tool 10 at the target pulling-out position G (see FIG. 5).

As shown in FIGS. 7, 8, and 10, a width T1 of the convex portions 611 and 701 in a region R1 where the linear portion 21 is formed is smaller than a width T2 of the convex portions 611 and 701 in a region R2 where the circular portion 22 is formed. In principle, it is preferable to minimize the width of the convex portions 611 and 701 in consideration of a heat capacity of the refrigerant flow path 80. On the other hand, in order to perform the terminal end forming step and the pulling-out step described above, the convex portions 611 and 701 having a width larger than that of the circular portion 22 are required. Therefore, by increasing only a width of a terminal end of the convex portions 611 and 701 in which the circular portion 22 is formed, it is possible to form the circular portion 22 in the terminal end forming step and the pulling-out step while ensuring the heat capacity of the refrigerant flow path 80.

In this way, by applying the friction stir welding method described above to the manufacture of the battery pack 50 and forming the refrigerant flow path 80 between the bottom plate 61 of the battery case 60 and the cover plate 70, a welding strength between the bottom plate 61 and the cover plate 70 can be improved. By improving the welding strength between the bottom plate 61 and the cover plate 70, it is possible to prevent leakage of the refrigerant even when a water pressure of the refrigerant flowing between the bottom plate 61 and the cover plate 70 acts on a welding region.

In the present embodiment, a case where the convex portion 611 of the bottom plate 61 and the convex portion 701 of the cover plate 70 are brought into contact with each other and subjected to the friction stir welding to form the refrigerant flow path 80 by the concave portions 612 and 702 is shown as an example, but the present invention is not limited thereto. For example, only one side may be a convex portion and the other side may be a flat portion, and the refrigerant flow path 80 may be formed between the flat portion and a concave portion.

Although various embodiments have been described above with reference to the drawings, it is needless to say that the present invention is not limited to these examples. It is apparent that those skilled in the art can conceive of various modifications and alterations within the scope described in the claims, and it is understood that such modifications and alterations naturally fall within the technical scope of the present invention. In addition, respective constituent elements in the above-described embodiment may be freely combined without departing from the gist of the invention.

For example, although the battery pack 50 has been shown as an application example of the friction stir welding method described above, the present invention is not limited thereto, and the friction stir welding method can be applied to one in which at least two metal members, which are members to be welded, are welded.

In the present specification, at least the following matters are described. Although corresponding constituent elements or the like in the above-described embodiment are shown in parentheses, the present invention is not limited thereto.

(1) A friction stir welding method of welding at least two members to be welded (metal members M1 and M2) by overlapping the members to be welded and moving a welding tool (welding tool 10), the friction stir welding method including:
forming a closed space at a terminal end of a welding line (welding line 20) which is a movement track of the welding tool; and
moving the welding tool to inside the closed space and pulling out the welding tool from the members to be welded.

According to (1), by pulling out the welding tool at the inside of the closed space formed at the terminal end of the welding line which is the movement track of the welding tool, a welding region can be formed outside the pulling-out position, thus a welding strength can be improved. In addition, a sealing performance can be improved in a case where a space between the two members to be welded is to be a sealed space.

(2) The friction stir welding method according to (1),
in which the closed space has a circular shape,
the welding tool has a columnar shape with a projection (probe 12) at a distal end,
the welding line is a movement track of an axis of the projection, and
a diameter (diameter D1) of the closed space is larger than a diameter (diameter D2) of the projection of the welding tool.

According to (2), the projection of the welding tool, which forms a hole portion after the welding tool is pulled out, can be positioned inside the closed space, so that the welding strength and the sealing performance can be appropriately improved.

(3) The friction stir welding method according to (1) or (2),
in which when forming the closed space at the terminal end, the closed space is formed such that parts of the welding line overlap each other.

According to (3), by moving the welding tool such that the parts of the welding line overlap each other, the closed space can be reliably formed.

(4) The friction stir welding method according to (3),
in which an overlapping amount of the welding line is 180° or less.

According to (4), by setting the overlapping amount of the welding line to be 180° or less, a time required for a welding treatment can be shortened.

(5) A battery pack (battery pack 50) including:
a battery module (battery module 51) in which a plurality of battery cells are laminated;
a battery case (battery case 60) that accommodates the battery module; and
a plate member (cover plate 70) that is welded to the battery case to form, between the plate member and the battery case, a flow path (refrigerant flow path 80) configured to allow a fluid for battery temperature control to flow therethrough,
in which at least one of the battery case or the plate member includes a convex portion (convex portion 611, 701) protruding toward an other one of the battery case or the plate member,
the convex portion is welded by friction stir welding to form a welding portion,
the welding portion includes a linear portion (linear portion 21) extending in an extension direction of the convex portion and a circular portion (circular portion 22) formed at one of ends of the linear portion, and
a width of the circular portion is larger than a width of the linear portion.

According to (5), in the welding portion between the battery case and the plate member, the circular portion having the width larger than the width of the linear portion is formed on one of ends of the linear portion, and thus the welding strength can be improved. In addition, it is possible to improve a sealing performance of the flow path through which the fluid for battery temperature control flows and formed between the battery case and the plate member.

(6) The battery pack according to (5),
in which a hole portion (probe hole portion 12A) recessed from a side of the plate member toward a side of the battery case is formed in the circular portion.

According to (6), since the circular portion exists at a periphery of the hole portion from which the welding tool is pulled out, a welding strength at the periphery of the hole portion can be improved.

(7) The battery pack according to (5) or (6),
in which a width (width T1) of the convex portion in a region (region R1) where the linear portion is formed is smaller than a width (width T2) of the convex portion in a region (region R2) where the circular portion is formed.

According to (7), it is possible to form the circular portion having a high welding strength at one end of the linear portion by the friction stir welding while ensuring a heat capacity of the flow path through which the fluid for battery temperature control flows.

What is claimed is:

1. A friction stir welding method of welding at least two members to be welded by overlapping the members to be welded and moving a welding tool, the friction stir welding method comprising:
forming a closed space at a terminal end of a welding line which is a movement track of the welding tool; and
moving the welding tool to inside the closed space and pulling out the welding tool from the members to be welded.

2. The friction stir welding method according to claim 1,
wherein the closed space has a circular shape,
the welding tool has a columnar shape with a projection at a distal end,
the welding line is a movement track of an axis of the projection, and
a diameter of the closed space is larger than a diameter of the projection of the welding tool.

3. The friction stir welding method according to claim 1,
wherein when forming the closed space at the terminal end, the closed space is formed such that parts of the welding line overlap each other.

4. The friction stir welding method according to claim 3,
wherein an overlapping amount of the welding line is 180° or less.

5. A battery pack comprising:
a battery module in which a plurality of battery cells are laminated;
a battery case that accommodates the battery module; and
a plate member that is welded to the battery case to form, between the plate member and the battery case, a flow path configured to allow a fluid for battery temperature control to flow therethrough,
wherein at least one of the battery case or the plate member includes a convex portion protruding toward an other one of the battery case or the plate member,
the convex portion is welded by friction stir welding to form a welding portion,
the welding portion includes a linear portion extending in an extension direction of the convex portion and a circular portion formed at one of ends of the linear portion, and
a width of the circular portion is larger than a width of the linear portion.

6. The battery pack according to claim 5,
wherein a hole portion recessed from a side of the plate member toward a side of the battery case is formed in the circular portion.

7. The battery pack according to claim 5,
wherein a width of the convex portion in a region where the linear portion is formed is smaller than a width of the convex portion in a region where the circular portion is formed.
